(19) United States
(12) Patent Application Publication
(10) Pub. No.: US 2025/0200429 A1
(43) Pub. Date: Jun. 19, 2025

(54) AVOIDING GENERATIVE MODE COLLAPSE USING GUIDED IMAGE DIFFUSION MACHINE LEARNING MODELS

(71) Applicant: QUALCOMM Incorporated, San Diego, CA (US)

(72) Inventors: Samuel SHOWALTER, Irvine, CA (US); Risheek GARREPALLI, San Diego, CA (US); Debasmit DAS, San Diego, CA (US); Hyojin PARK, San Diego, CA (US); Munawar HAYAT, San Diego, CA (US); Fatih Murat PORIKLI, San Diego, CA (US)

(21) Appl. No.: 18/543,779

(22) Filed: Dec. 18, 2023

(51) Int. Cl. G06N 20/00

(52) U.S. Cl. CPC G06N 20/00

(57) ABSTRACT

Certain aspects of the present disclosure provide techniques and apparatus for improved machine learning. In an example method, a reference latent tensor generated based on a reference input to a diffusion machine learning model is accessed. A first latent tensor generated during a first iteration of processing data using a denoising backbone of the diffusion machine learning model is accessed, and a first intermediate tensor is generated based on processing the reference latent tensor and the first latent tensor using an auxiliary machine learning model. A second latent tensor is generated, during a second iteration of processing data using the denoising backbone, based on the first latent tensor and at least in part on the first intermediate tensor.

### INTRODUCTION

Aspects of the present disclosure relate to machine learning.

A wide variety of machine learning models have been trained for a similarly vast assortment of tasks in recent years. For example, generative models (e.g., generative adversarial models (GANs), diffusion models, and the like) have been trained to generate new output data (e.g., images or text) based on input prompts. In some cases, generative models have been trained to enable input editing based on various prompts. For example, some models are able to receive an input image (e.g., a picture of a sailboat) and a textual prompt indicating how to edit or transform the image (e.g., “make the sail green”). The generative image editing model can generate an edited image that is similar to the reference image, but modified in accordance with the prompt (e.g., an image of a sailboat with green sails).

### BRIEF SUMMARY

Certain aspects of the present disclosure provide a processor-implemented method, comprising: accessing a reference latent tensor generated based on a reference input to a diffusion machine learning model; accessing a first latent tensor generated during a first iteration of processing data using a denoising backbone of the diffusion machine learning model; generating a first intermediate tensor based on processing the reference latent tensor and the first latent tensor using an auxiliary machine learning model; and generating a second latent tensor, during a second iteration of processing data using the denoising backbone, based on the first latent tensor and at least in part on the first intermediate tensor.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for performing inverse diffusion using diffusion machine learning models with auxiliary guidance models, according to some aspects of the present disclosure.

FIG. 2 depicts an example workflow for using auxiliary components to assist a denoising backbone in a diffusion model, according to some aspects of the present disclosure.

FIG. 3 is a flow diagram depicting an example method for training auxiliary machine learning models to provide input for the denoising backbone of diffusion machine learning models, according to some aspects of the present disclosure.

FIG. 4 is a flow diagram depicting an example method for using auxiliary machine learning models to provide input for the denoising backbone of diffusion machine learning models, according to some aspects of the present disclosure.

FIG. 5 is a flow diagram depicting an example method for using an auxiliary machine learning model to generate intermediate input to a denoising backbone, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

Many conventional generative models are highly sensitive to mode collapse due to the manner in which the models are trained. For example, the trained models often exhibit high sensitivity to the model hyperparameters and input data (e.g., generating substantially different results given minor changes in hyperparameters, input reference images, and/or input prompts. Moreover, many conventional generative models do not exhibit diversity of generation across different random seeds (e.g., the same or highly similar output is generated even when the value(s) used to seed the generation changes substantially).

In some aspects of the present disclosure, a new architecture for diffusion machine learning models is provided in order to mitigate, eliminate, or at least reduce mode collapse while encouraging generative diversity. In some aspects, a diffusion model can be frozen (e.g., the parameters of a diffusion model may be trained during an initial training phase and then frozen), and a separate auxiliary model or encoder may be trained to assist or guide the iterative denoising backbone during the inverse diffusion phase of processing data using the diffusion model. In some aspects, the auxiliary model may utilize inputs such as the reference image embedding, prompt embedding, and/or the current (noisy) latent tensor for the current iteration in order to generate additional inputs for the denoising backbone. This auxiliary guidance or control can substantially improve diversity of generation and reduce the probability of mode collapse in generative machine learning.

Some aspects of the present disclosure provide improved techniques and architectures for text-guided image editing. In such tasks, a machine learning model is provided with a reference image and a textual prompt or instruction. The model is tasked with generating an output image that preserves the original image while also fulfilling the textual instruction. In some aspects of the present disclosure, supervised training is used to train the machine learning model(s) to perform such image generation.

### Example Workflow for Performing Inverse Diffusion Using Diffusion Machine Learning Models with Auxiliary Guidance Models

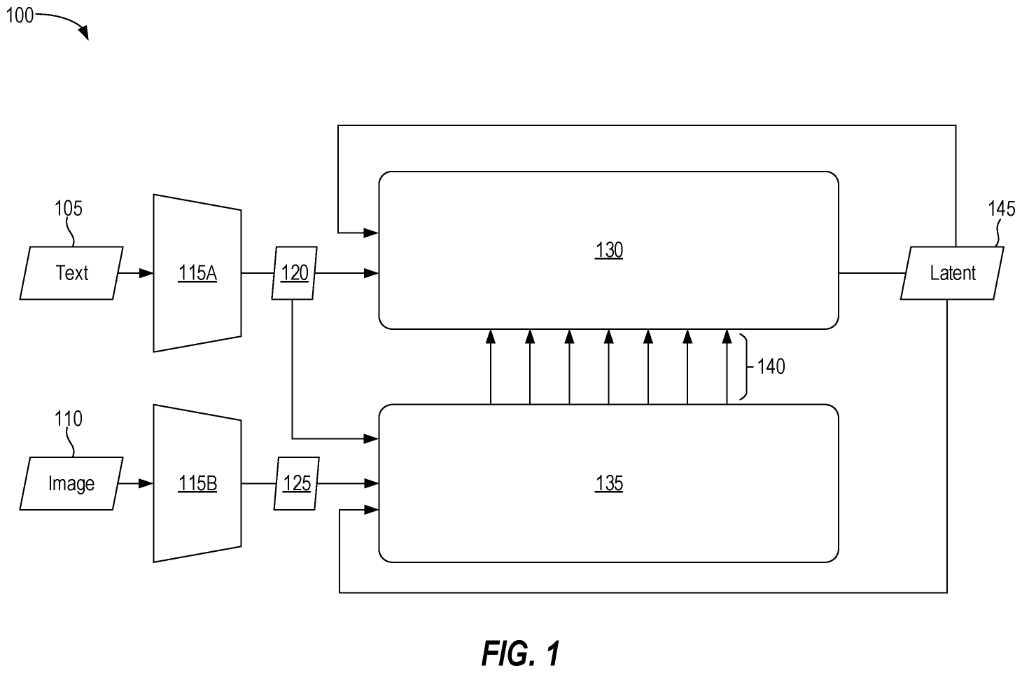

FIG. 1 depicts an example workflow 100 for performing inverse diffusion using diffusion machine learning models with auxiliary guidance models, according to some aspects of the present disclosure. In some aspects, the workflow 100 is used by a machine learning system (e.g., a computing system configured to perform machine learning operations).

In the illustrated example, an input text 105 and image 110 are provided to a generative machine learning model. In some aspects, the image 110 (which may be referred to as a “reference image” or a “reference input” in some aspects) is used to provide a basis for the generation process. That is, the image 110 may be used to indicate, to the model, what the desired output is. For example, if the image 110 depicts a statue, the model may generate an output image that is visually similar to the depicted statute (while fulfilling the text instruction).

In some aspects, the text 105 (which may be referred to as a “prompt” or as “text input” in some aspects) is a textual instruction indicating desired modification(s) to the image 110. In some aspects, the text 105 is natural language text. In some aspects, the text 105 can be provided by a user (e.g., by typing the prompt). In some aspects, the text 105 may be generated by processing other input (e.g., using voice-to-text algorithms). In some aspects, the text 105 is used to guide or condition the generation process. For example, continuing the above example, the image 110 may depict a statue, and the text may include an instruction such as “change the statue material from bronze to marble.”

In the illustrated example, the text 105 is processed by a first encoder 115A to generate a prompt tensor 120 (referred to in some aspects as a prompt encoding and/or a prompt embedding). The image 110 is similarly processed by a second encoder 115B to generate a latent tensor 125 (referred to in some aspects as a reference latent tensor, an image embedding, and/or an image encoding). Generally, the workflow 100 may use a variety of encoders 115A and 115B, depending on the particular implementation. Each encoder 115 generally corresponds to a machine learning model or component (e.g., a component that uses parameters with learned values to process input) that generates an encoding or embedding for the respective inputs.

For example, in some aspects, the encoders 115A and 115B correspond to contrastive language-image pre-training (CLIP) encoders, where the encoders learn to generate text and image embeddings that are aligned in the latent space (e.g., where the embedding for the text “dog” is similar to the embedding for a picture of a dog). In some aspects, the encoders 115 may be pre-trained components (e.g., trained by the machine learning system and/or by another system).

Although the illustrated example depicts providing the text 105 and image 110 directly to the encoders 115, in some aspects, one or more other interim operations may be first performed. In the illustrated example, the prompt tensor 120 is provided to a denoising backbone 130 and an auxiliary machine learning model 135. The latent tensor 125 is similarly provided to the auxiliary machine learning model 135. Although the illustrated example depicts providing the prompt tensor 120 and latent tensor 125 directly to the denoising backbone 130 and auxiliary machine learning model 135 for conceptual clarity, in some aspects, one or more other interim operations (e.g., pre-processing steps) may be performed.

The denoising backbone 130 generally corresponds to a machine learning model or component having parameters with values learned during a training phase. In some aspects, the denoising backbone 130 may be a pre-trained architecture (e.g., trained by the machine learning system and/or by another system).

In some aspects, the denoising backbone is used to iteratively denoise input latent tensors to generate an output image. For example, the machine learning system may initialize a latent tensor for a first iteration using Gaussian random noise (rather than the latent tensor 125 representing the input image 110), and the noisy latent tensor may be processed by the denoising backbone 130 to generate a latent tensor 145 (referred to in some aspects as a denoised latent tensor). This latent tensor 145 is then processed as input to the denoising backbone 130 again, and the process is repeated iteratively (e.g., for a defined number of iterations) until a final latent tensor 145 is generated. This final latent tensor may be used to generate the output image (e.g., by processing the final latent tensor using a feedforward or convolutional neural network).

In some aspects, rather than beginning with a noisy latent tensor, the workflow 100 begins with the reference latent tensor 125. That is, during a first iteration of processing data using the denoising backbone 130, the latent tensor 125 may be used as the latent input. During subsequent iterations, the latent tensor 145 is used. That is, at a timestep t, the latent tensor 145 generated during the immediately prior timestep (e.g., t−1) is processed by the denoising backbone 130 to generate a new latent tensor 145, which may be used during the immediately subsequent iteration (e.g., at t+1). In some aspects, by convention, the indices used to describe iterations of the denoising backbone 130 decrement (e.g., where the first iteration is step T, the next iteration is T−1, and the final iteration is at time t=0).

In some aspects, for the first iteration (when no latent tensor 145 is available), the reference image 110 may be processed to generate the first latent tensor. For example, the latent tensor 125 may be used as the first input latent to the denoising backbone 130. In some aspects, a first latent tensor is generated for the image 110 by processing the image 110 to iteratively add noise (e.g., during a forward diffusion process, adding noise based on trained parameters). This noisy latent (after a defined number of iterations) can then be used as the latent tensor provided as input to the denoising backbone 130 during the first iteration.

As illustrated, the denoising backbone 130 further receives, as input, the prompt tensor 120. In some aspects, the denoising backbone 130 generates the latent tensor 145 based in part on the prompt tensor 120. For example, as discussed above, the denoising backbone 130 may be trained to generate an output that generally aligns with the latent tensor 125 while also satisfying the prompt tensor 120. That is, the prompt tensor 120 may be used to “condition” or “guide” the denoising process.

In the illustrated example, the auxiliary machine learning model 135 is also used to provide guidance or conditioning to the denoising backbone 130, as illustrated by the connections 140. Specifically, the auxiliary machine learning model 135 may generate one or more intermediate or interim tensors (also referred to in some aspects as auxiliary tensors or inputs) that can be used, along with the prompt tensor 120, to guide the diffusion process. In some aspects, the auxiliary machine learning model 135 is trained using pre-trained encoders 115 and denoising backbone 130. That is, the parameters of the auxiliary machine learning model 135 may be updated during a training phase while the parameters of the encoders 115 and the denoising backbone 130 are frozen.

As illustrated, the auxiliary machine learning model 135 receives, as input, the latent tensor 145 generated during the previous iteration, the prompt tensor 120, and the reference latent tensor 125. The auxiliary machine learning model 135 generally corresponds to a trained component (e.g., using parameters having values that were learned during a training phase) that generates auxiliary guidance which is provided as input to the denoising backbone 130.

Stated differently, in some aspects, the auxiliary machine learning model 135 may process the latent tensor 145 from the previous iteration (e.g., xₜ), the prompt tensor 120 (e.g., zₜₑₓₜ), and the image latent tensor 125 (e.g., z_{image}) to generate a set of intermediate guidance tensor(s) (passed via connections 140 to the denoising backbone 130). The denoising backbone 130 processes the latent tensor 145 from the prior iteration (xₜ), the prompt tensor 120 (zₜₑₓₜ) and the intermediate guidance tensor(s) to generate a new latent tensor 145 for the next iteration (e.g., xₜ₋₁).

The denoising backbone 130 and auxiliary machine learning model 135 may be used to iteratively process the latent tensor for any number of iterations. In some aspects, the number of iterations is a hyperparameter configurable by a user. Although not included in the illustrated example, in some aspects, the denoising backbone 130 and/or auxiliary machine learning model 135 may also receive other inputs, such as a time step value or embedding (e.g., an embedding indicating which iteration is being processed).

In some aspects, after the desired number of iterations are performed, the latent tensor 145 generated during the last iteration can be used to generate the output image from the model. For example, the latent tensor 145 may be processed by one or more other components, which may include trained model components, such as convolutional layer(s), multilayer perceptrons (MLPs), and the like. The output image is generally visually similar to the reference image 110 modified in accordance with the prompt text 105.

In some aspects, by using the auxiliary machine learning model 135 as an additional source of control or guidance on the denoising process, the depicted architecture is able to avoid (or at least reduce) generative collapse (e.g., where the model generates limited or repetitive outputs regardless of inputs). Further, the additional guidance provided by the auxiliary machine learning model 135 may improve or enhance generative diversity (e.g., generating substantially different outputs when different random seeds are used as input).

Example Workflow for Using Auxiliary Components to Assist a Denoising Backbone in a Diffusion Model

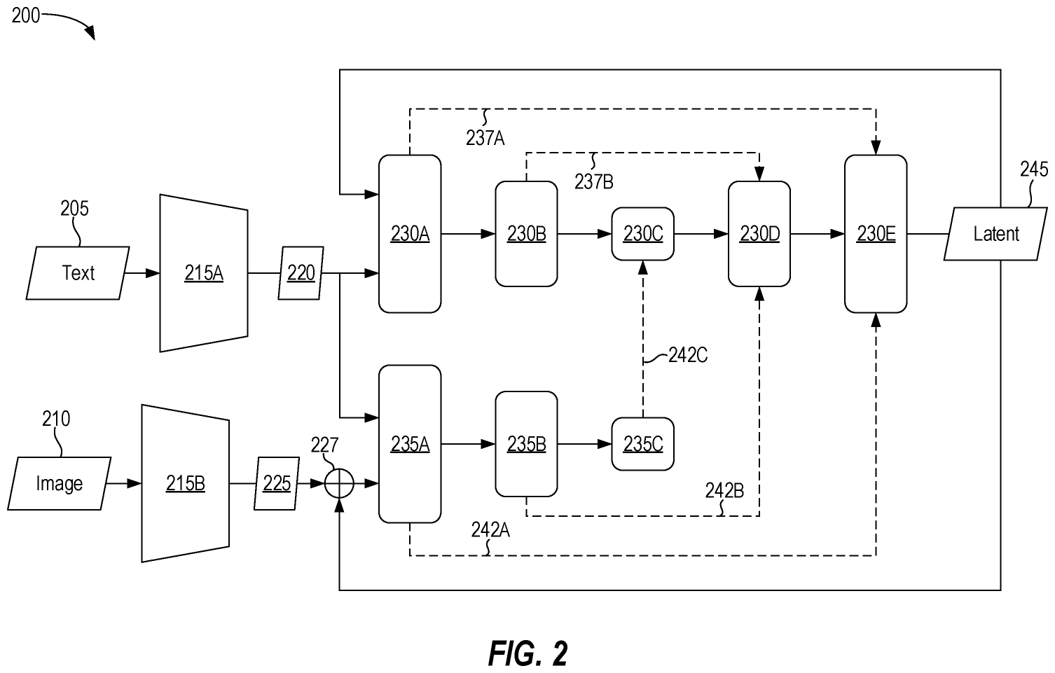

FIG. 2 depicts an example workflow 200 for using auxiliary components to assist a denoising backbone in a diffusion model, according to some aspects of the present disclosure. In some aspects, the workflow 200 is used by a machine learning system, such as the machine learning system discussed above with reference to FIG. 1. In some aspects, the workflow 200 provides more detail for the operations and architecture of the denoising backbone 130 of FIG. 1 and/or the auxiliary machine learning model 135 of FIG. 1.

In the illustrated example, an input text 205 and image 210 are provided to a generative machine learning model. In some aspects, the image 210 (which may correspond to the image 110 of FIG. 1) is used to provide a basis for the generation process, as discussed above. In some aspects, the text 205 (which may correspond to the text 105 of FIG. 1) is a textual instruction indicating desired modification(s) to the image 210.

In the illustrated example, the text 205 is processed by a first encoder 215A (which may correspond to the encoder 115A of FIG. 1) to generate a prompt tensor 220. The image 210 is similarly processed by a second encoder 215B (which may correspond to the encoder 115B of FIG. 1) to generate a latent tensor 225. Each encoder 215 generally corresponds to a machine learning model or component (e.g., a component that uses parameters with learned values to process input) that generates an encoding or embedding for the respective inputs. In some aspects, as discussed above, the encoders 215 may be pre-trained components (e.g., trained by the machine learning system and/or by another system).

In the illustrated example, the prompt tensor 220 and a latent tensor 245 (generated during a prior iteration of the denoising backbone) are provided as input to a first encoder block 230A. In some aspects, the blocks 230A-E are components of a denoising backbone, such as the denoising backbone 130 of FIG. 1. Specifically, in the illustrated example, the denoising backbone comprises a U-Net architecture (e.g., an architecture comprising a sequence of encoders in progressively compressed form, such as smaller resolution or dimensionality, followed by a sequence of decoders to progressively return the compressed data to the original size). In the illustrated example, the denoising backbone includes a sequence of encoder blocks 230A-B (also referred to as denoiser encoder blocks in some aspects) that process data at progressively smaller resolutions, followed by a sequence of decoder blocks 230D-E (also referred to a denoiser decoder blocks in some aspects) that upscale the data until an output denoised latent tensor 245 is generated. In some aspects, the block 230C may be alternatively referred to as an encoder or a decoder (or both). That is, the block 230C may comprise two portions: an encoder portion and a decoder portion, in order to connect the encoder blocks 230A-B with the decoder blocks 230D-E. In some aspects, each of the backbone encoder blocks 230A-B may perform operations such as convolution operations, downsampling operations, and the like. Similarly, in some aspects, each of the backbone decoder blocks 230D-E may perform operations such as convolution operations, upsampling operations, and the like.

In the illustrated example, the denoising backbone includes a set of residual connections 237A-B (also referred to in some aspects as skip connections) where data from one component of the backbone is provided directly as input to a downstream component (while bypassing one or more other components or operations in the sequence). Specifically, the first encoder block 230A provides a residual tensor (via residual connection 237A) to the last decoder block 230E, the second encoder block 230B provides a residual tensor (via the residual connection 237B) to the penultimate decoder block 230D, and so on. Although not depicted in the illustrated example, in some aspects, the block 230C may similarly include a residual connection from the encoder portion of the block 230C to the decoder portion of the block 230C. That is, the block 230C may actually be implemented as two blocks: an encoder block (similar to the encoder blocks 230A-B) and a decoder block (similar to the decoder blocks 230D-E). Generally, each residual connection 237 is used to provide data from a given encoder component to a corresponding decoder component that operates on the same resolution or scale of data.

In some aspects, the residual tensors provided along the residual connections 237 are aggregated with corresponding intermediate tensors within each decoder block 230 (e.g., using element-wise summation or averaging) in order to generate the output of the decoder block 230.

Specifically, in the depicted denoising backbone, the encoder block 230A processes the prompt tensor 220 and latent tensor 245 to generate a first intermediate tensor which is provided as input to the encoder block 230B, as well as to the decoder block 230E (via the residual connection 237A). The encoder block 230B processes the first intermediate tensor (generated by the encoder block 230A) to generate a second intermediate tensor, which is provided as input to the block 230C (as well as to the decoder block 230D via the residual connection 237B). The block 230C processes the second intermediate tensor (generated by the encoder block 230B) to generate a third intermediate tensor, which is provided as input to the decoder block 230D. The decoder block 230D processes the third intermediate tensor (generated by the block 230C) and the second intermediate tensor (received via the residual connection 237B) to generate a fourth intermediate tensor. The fourth intermediate tensor is used as input to the decoder block 230E. The decoder block 230E processes the fourth intermediate tensor (along with the first intermediate tensor received via the residual connection 237A) to generate the latent tensor 245. Although five blocks 230 are depicted for conceptual clarity, in other aspects, the denoising backbone may use any number of such blocks (e.g., any number of encoders and decoders).

In some aspects, blocks 235A-C are components of an auxiliary machine learning model, such as the auxiliary machine learning model 135 of FIG. 1. Specifically, in the illustrated example, the auxiliary machine learning model comprises a sequence of encoder blocks 235A-C(also referred to as auxiliary encoder blocks in some aspects) that process data at progressively smaller resolutions. As illustrated, each encoder block 235 of the auxiliary machine learning model provides an auxiliary or control tensor to a corresponding decoder block 230 of the denoising backbone via connections 242A-C (which may correspond to the connections 140 of FIG. 1). For example, each connection 242 may be used to provide data from a given encoder block 235 of the auxiliary machine learning model to a corresponding decoder block 230 that operates on the same resolution or scale of data. In some aspects, each of the auxiliary encoder blocks 235 may perform operations such as convolution operations, downsampling operations, and the like.

In the illustrated example, the prompt tensor 220 is also provided to a first encoder block 235A. In the illustrated example, the reference latent tensor 225 is also aggregated with the latent tensor 245 (via operation 227), and the aggregated result is also provided as input to the first encoder block 235A. The operation 227 may generally include a variety of operations, such as element-wise addition or summation, concatenating the tensors, averaging the tensors, and the like.

Specifically, in the depicted architecture, the encoder block 235A processes the prompt tensor 220 and the aggregation of the latent tensor 225 with the latent tensor 245 in order to generate a first intermediate tensor which is provided as input to the encoder block 235B. This first intermediate tensor is also used as an auxiliary input to the decoder block 230E (via the connection 242A). The encoder block 235B processes the first intermediate tensor (generated by the encoder block 235A) to generate a second intermediate tensor, which is provided as input to the block 235C (as well as being used as an auxiliary input to the decoder block 235D via the connection 242B). The block 235C processes the second intermediate tensor (generated by the encoder block 235B) to generate a third intermediate tensor, which is provided as an auxiliary input to the decoder portion of the block 230C (via the connection 242C). Although three blocks 235 are depicted for conceptual clarity, in other aspects, the auxiliary machine learning model may use any number of such blocks (e.g., any number of encoders). In some aspects, the auxiliary machine learning model includes an encoder block 235 for each decoder block 230 of the denoising backbone.

In some aspects, the residual tensors (provided via the residual connections 237) and the auxiliary tensors (provided via the connections 242) are aggregated before being processed by the decoder blocks 230. Specifically, the residual tensor output by the encoder block 235C may be aggregated with the intermediate or residual tensor generated by the encoder portion of the block 230C (not pictured). Similarly, the auxiliary tensor provided via the connection 242B may be combined with the residual tensor provided via residual connection 237B, and the decoder block 230D may then process this combined data. Additionally, the auxiliary tensor provided via the connection 242A may be combined with the residual tensor provided via residual connection 237A, and the decoder block 230E may then process the aggregated data. Generally, a variety of aggregation operations may be used. For example, in some aspects, the residual tensor provided to a given decoder block 230 may be summed (e.g., using element-wise summation) or averaged (e.g., using element-wise averaging) with the auxiliary tensor provided to the given decoder block 230. The combined data can then be used where the residual tensor would have been directly used (in conventional machine learning systems that lack the auxiliary machine learning model).

As discussed above, the denoising backbone and auxiliary machine learning model may thereby be used for any number of iterations to iteratively generate progressively denoised latent tensors 245. After the desired number of iterations are performed, the latent tensor 245 generated during the last iteration can be used to generate the output image from the model. For example, the latent tensor 145 may be processed by one or more other components, which may include trained model components, such as convolutional layer(s), multilayer perceptrons (MLPs), and the like. The output image is generally visually similar to the reference image 210 modified in accordance with the prompt text 205.

In some aspects, by using the auxiliary machine learning model as an additional source of control or guidance on the denoising process, the depicted architecture is able to avoid (or at least reduce) generative collapse (e.g., where the model generates limited or repetitive outputs regardless of inputs). Further, the additional guidance provided by the auxiliary machine learning model may improve or enhance generative diversity (e.g., generating substantially different outputs when different random seeds are used as input).

### Example Method for Training Auxiliary Machine Learning Models to Provide Input for the Denoising Backbone of Diffusion Machine Learning Models

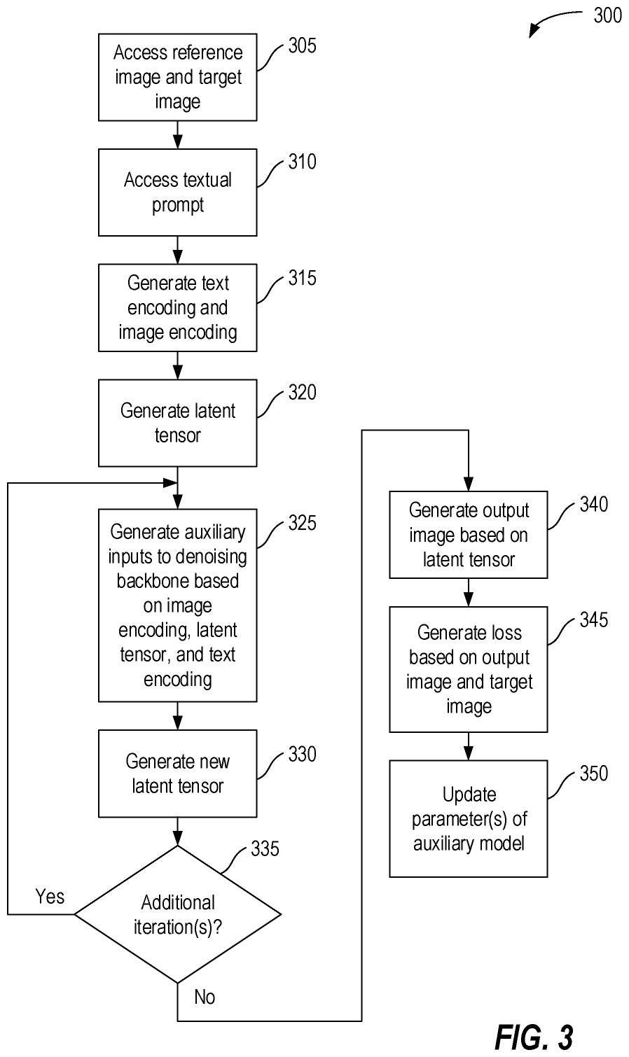

FIG. 3 is a flow diagram depicting an example method 300 for training auxiliary machine learning models to provide input for the denoising backbone of diffusion machine learning models, according to some aspects of the present disclosure. In some aspects, the method 300 is performed by a machine learning system, such as the machine learning system discussed above with reference to FIGS. 1-2. In some aspects, the method 300 provides more detail for the training process of an auxiliary machine learning model, such as the auxiliary machine learning model 135 of FIG. 1.

At block 305, the machine learning system accesses a reference image and a target image. As used herein, “accessing” data can generally include receiving, requesting, retrieving, obtaining, collecting, or otherwise gaining access to the data. For example, the reference image and target image may be received from a local source, a remote source, a user, and the like. In some aspects, the reference image (which may correspond to the image 110 of FIG. 1 and/or the image 210 of FIG. 2) may generally represent or be used as the basis for the desired model output. That is, the reference image may be used as the base or start point of the generation process, where the model seeks to generate an output image that is visually similar to the reference image (with one or more modifications in accordance with the text prompt).

In some aspects, the target image generally corresponds to a ground truth or label for the input reference image. For example, suppose the reference image depicts the Eiffel tower on a sunny day. If the prompt is to change the scene to a stormy night, the target image may be a picture of the Eiffel tower from the same (or a similar) vantage point, but on a stormy night. In some aspects, the target image may comprise a real image (e.g., an actual photograph of the Eiffel tower on a stormy night) or a simulated or edited image (e.g., if the reference image was edited by a user or other program to replace the sunny scene with a stormy one).

At block 310, the machine learning system accesses a textual prompt (which may correspond to the text 105 of FIG. 1, and/or the text 205 of FIG. 2). As discussed above, the textual prompt generally comprises natural language text indicating what change(s) are desired for the reference image. For example, as discussed above, the text may indicate to change the weather from sunny to stormy, to change the color of an object depicted in the reference image, to replace a depicted object with another object, and the like. The text prompt may generally indicate any edit or modification to the reference image. In some aspects, the reference image, target image, and textual prompt are collectively referred to as a training sample or exemplar.

At block 315, the machine learning system generates a text encoding (e.g., the prompt tensor 120 of FIG. 1 and/or the prompt tensor 220 of FIG. 2) and an image encoding for the reference image (e.g., the latent tensor 125 of FIG. 1 and/or the latent tensor 225 of FIG. 2). In some aspects, as discussed above, the image encoding is evaluated, by the auxiliary machine learning model, at each iteration or time step in order to generate auxiliary input for the denoising backbone in order to guide or control the denoising process (e.g., to cause the output image to be more similar to the reference image).

In some aspects, to generate the text encoding, the machine learning system processes the textual prompt using a text encoder (e.g., the encoder 115A of FIG. 1 and/or the encoder 215A of FIG. 2). In some aspects, to generate the image encoding, the machine learning system processes the reference image using an image encoder (e.g., the encoder 115B of FIG. 1 and/or the encoder 215B of FIG. 2).

At block 320, the machine learning system generates a first latent tensor to begin the denoising process. In some aspects, as discussed above, the image encoding (e.g., the latent tensor 125 of FIG. 1) may be used as the first latent tensor. In some aspects, the first latent tensor is generated by processing the reference image during a forward-diffusion pipeline (e.g., iteratively adding Gaussian noise over one or more iterations or time steps). This latent tensor may be the same as the latent tensor 125 of FIG. 1 (e.g., the same embedding used by the auxiliary model to guide the denoising process), or may be a separate tensor.

At block 325, the machine learning system generates a set of auxiliary inputs for the denoising backbone based on the image encoding, the latent tensor, and the text encoding. For example, the machine learning system may use an auxiliary machine learning model (e.g., the auxiliary machine learning model 135 of FIG. 1 and/or the blocks 235 of FIG. 2) to process the text encoding, latent tensor, and reference image encoding. As discussed above, these auxiliary inputs may be provided to or used as input for the denoising backbone (e.g., the denoising backbone 130 of FIG. 1 and/or the blocks 230 of FIG. 2), such as via one or more auxiliary or residual connections (e.g., the connections 140 of FIG. 1 and/or the connections 242 of FIG. 2). As discussed above, in some aspects, other inputs such as a time or iteration embedding may also be provided as input to the auxiliary machine learning model.

At block 330, the machine learning system generates a new latent tensor based on the previous latent tensor (generated at block 320), the text encoding (generated at block 315), and the auxiliary inputs (generated at block 325). For example, as discussed above, the machine learning system may process these inputs using a denoising backbone (e.g., the denoising backbone 130 of FIG. 1 and/or the blocks 230 of FIG. 2) to generate the new latent tensor. As discussed above, in some aspects, other inputs such as a time or iteration embedding may also be provided as input to the denoising backbone.

At block 335, the machine learning system determines whether at least one denoising iteration remains to be performed. If so, the method 300 returns to block 325 to begin a new iteration. In some aspects, during each subsequent iteration, the machine learning system uses the latent tensor generated during the previous iteration (at block 330) when generating the new auxiliary inputs (at block 325) and the new latent tensor (at block 330).

If no additional iterations remain, the method 300 continues to block 340. At block 340, the machine learning system generates an output image based on the latent tensor generated (at block 330) during the final iteration of processing data using the denoising backbone. For example, as discussed above, the machine learning system may process the latent tensor using one or more trained components or modules, such as one or more feedforward components, convolution components, MLPs, attention modules, and the like.

At block 345, the machine learning system generates a loss based on the output image and the target image. That is, the machine learning system generates a loss reflecting the difference(s) between the output image (generated by the model) and the target image (which is the desired output). Generally a wide variety of loss formulations may be used to generate the loss, depending on the particular implementation. In some aspects, in addition to or instead of generating the loss based on the output image and target image, the machine learning system may generate the loss based directly on the latent tensors. For example, the machine learning system may compute the loss based on comparing the latent generated by the model in the last iteration (e.g., the latent tensor 145 of FIG. 1 and/or the latent tensor 245 of FIG. 2) with an embedding of the target image (e.g., generated by processing the target image using an image encoder, such as the encoder 115B of FIG. 1 and/or the encoder 215B of FIG. 2).

At block 350, the machine learning system updates the parameter(s) of the auxiliary machine learning model based on the generated loss. In some aspects, as discussed above, the parameters of the other trained components (e.g., the encoders, denoising backbone, and/or components used to generate an output image based on the latent tensor) may be frozen or static during training of the auxiliary machine learning model. Generally, the particular operations or techniques used to update the auxiliary model parameters may vary depending on the particular implementation. For example, if the auxiliary model is a neural network, the machine learning system may use backpropagation and gradient descent to update the parameters.

Although the illustrated example depicts refining the auxiliary model based on one exemplar (e.g., a single reference image with a corresponding target image), in some aspects, the method 300 may be repeated for any number of exemplars. Further, although the illustrated example depicts updating the model based on a single exemplar at a time (e.g., using stochastic gradient descent), the machine learning system may alternatively update the model based on batches of exemplars (e.g., using batch gradient descent).

As discussed above, by using the auxiliary machine learning model as an additional source of control or guidance on the denoising process, the method 300 may be able to provide a diffusion model that avoids (or at least reduces) generative collapse while improving or enhancing generative diversity using the diffusion machine learning model and the auxiliary model.

### Example Method for Using Auxiliary Machine Learning Models to Provide Input for the Denoising Backbone of Diffusion Machine Learning Models

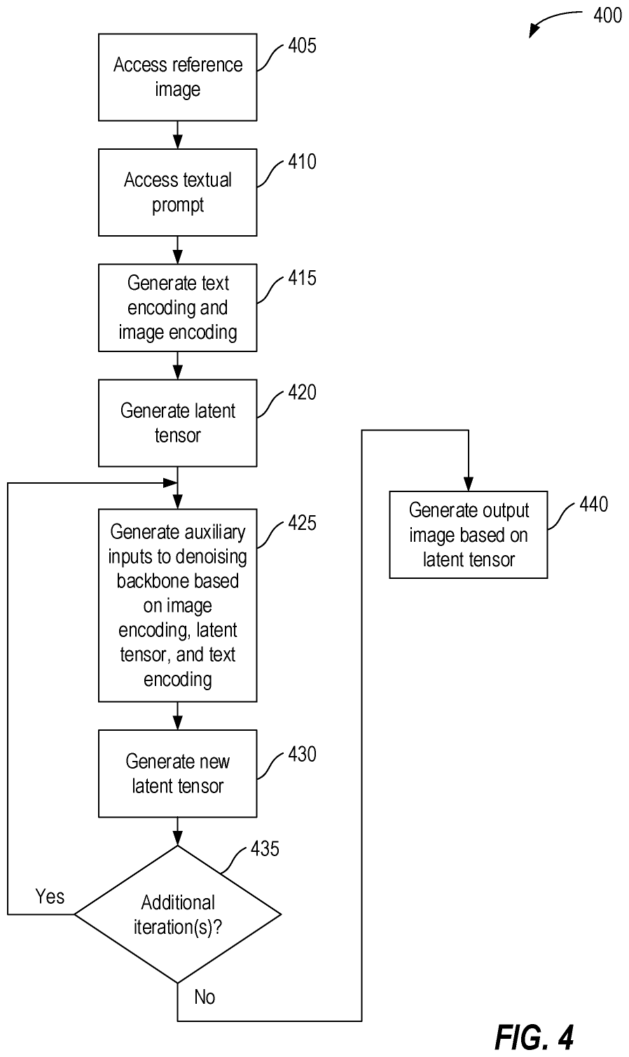

FIG. 4 is a flow diagram depicting an example method for using auxiliary machine learning models to provide input for the denoising backbone of diffusion machine learning models, according to some aspects of the present disclosure. In some aspects, the method 400 is performed by a machine learning system, such as the machine learning system discussed above with reference to FIGS. 1-3. In some aspects, the method 400 provides more detail for the runtime image generation or editing process using diffusion model and an auxiliary machine learning model, such as the auxiliary machine learning model 135 of FIG. 1.

At block 405, the machine learning system accesses a reference image. In some aspects, the reference image (which may correspond to the image 110 of FIG. 1 and/or the image 210 of FIG. 2) may generally represent or be used as the basis for the desired model output. That is, the reference image may be used as the base or start point of the generation process, where the model seeks to generate an output image that is visually similar to the reference image (with one or more modifications in accordance with the text prompt).

At block 410, the machine learning system accesses a textual prompt (which may correspond to the text 105 of FIG. 1, and/or the text 205 of FIG. 2). As discussed above, the textual prompt generally comprises natural language text indicating what change(s) are desired for the reference image. The text prompt may generally indicate any edit or modification to the reference image. In some aspects, the reference image and textual prompt are collectively referred to as an input sample.

At block 415, the machine learning system generates a text encoding (e.g., the prompt tensor 120 of FIG. 1 and/or the prompt tensor 220 of FIG. 2) and an image encoding for the reference image (e.g., the latent tensor 125 of FIG. 1 and/or the latent tensor 225 of FIG. 2). In some aspects, as discussed above, the image encoding is evaluated, by the auxiliary machine learning model, at each iteration or time step in order to generate auxiliary input for the denoising backbone in order to guide or control the denoising process (e.g., to cause the output image to be more similar to the reference image).

In some aspects, to generate the text encoding, the machine learning system processes the textual prompt using a text encoder (e.g., the encoder 115A of FIG. 1 and/or the encoder 215A of FIG. 2). In some aspects, to generate the image encoding, the machine learning system processes the reference image using an image encoder (e.g., the encoder 115B of FIG. 1 and/or the encoder 215B of FIG. 2).

At block 420, the machine learning system generates a first latent tensor to begin the denoising process. In some aspects, as discussed above, the image encoding (e.g., the latent tensor 125 of FIG. 1) may be used as the first latent tensor. In some aspects, the first latent tensor is generated by processing the reference image during a forward-diffusion pipeline (e.g., iteratively adding Gaussian noise over one or more iterations or time steps). This latent tensor may be the same as the latent tensor 125 of FIG. 1 (e.g., the same embedding used by the auxiliary model to guide the denoising process), or may be a separate tensor.

At block 425, the machine learning system generates a set of auxiliary inputs for the denoising backbone based on the image encoding, the latent tensor, and the text encoding. For example, the machine learning system may use an auxiliary machine learning model (e.g., the auxiliary machine learning model 135 of FIG. 1 and/or the blocks 235 of FIG. 2) to process the text encoding, latent tensor, and reference image encoding. As discussed above, these auxiliary inputs may be provided to or used as input for the denoising backbone (e.g., the denoising backbone 130 of FIG. 1 and/or the blocks 230 of FIG. 2), such as via one or more auxiliary or residual connections (e.g., the connections 140 of FIG. 1 and/or the connections 242 of FIG. 2). As discussed above, in some aspects, other inputs such as a time or iteration embedding may also be provided as input to the auxiliary machine learning model.

At block 430, the machine learning system generates a new latent tensor based on the previous latent tensor (generated at block 420), the text encoding (generated at block 415), and the auxiliary inputs (generated at block 425). For example, as discussed above, the machine learning system may process these inputs using a denoising backbone (e.g., the denoising backbone 130 of FIG. 1 and/or the blocks 230 of FIG. 2) to generate the new latent tensor. As discussed above, in some aspects, other inputs such as a time or iteration embedding may also be provided as input to the denoising backbone.

At block 435, the machine learning system determines whether at least one denoising iteration remains to be performed. If so, the method 400 returns to block 425 to begin a new iteration. In some aspects, during each subsequent iteration, the machine learning system uses the latent tensor generated during the previous iteration (at block 430) when generating the new auxiliary inputs (at block 425) and the new latent tensor (at block 430).

If no additional iterations remain, the method 400 continues to block 440. At block 440, the machine learning system generates an output image based on the latent tensor generated (at block 430) during the final iteration of processing data using the denoising backbone. For example, as discussed above, the machine learning system may process the latent tensor using one or more trained components or modules, such as one or more feedforward components, convolution components, MLPs, attention modules, and the like.

As discussed above, by using the auxiliary machine learning model as an additional source of control or guidance on the denoising process, the machine learning system may be able to avoid (or at least reduce) generative collapse while improving or enhancing generative diversity using the diffusion machine learning model.

### Example Method for Using an Auxiliary Machine Learning Model to Generate Intermediate Input to a Denoising Backbone

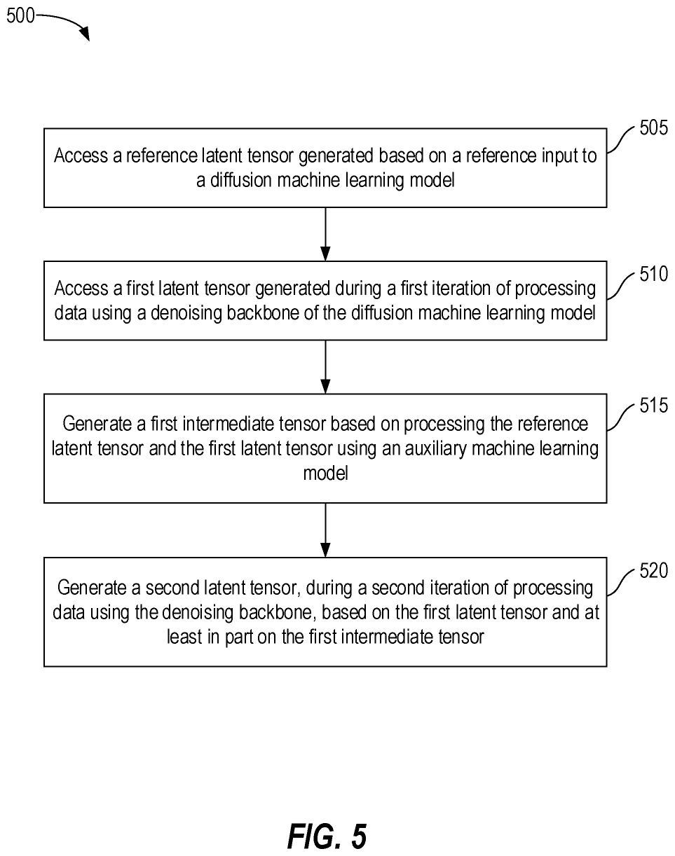

FIG. 5 is a flow diagram depicting an example method 500 for using an auxiliary machine learning model to generate intermediate input to a denoising backbone, according to some aspects of the present disclosure.

At block 505, a reference latent tensor generated based on a reference input to a diffusion machine learning model is accessed.

At block 510, a first latent tensor generated during a first iteration of processing data using a denoising backbone of the diffusion machine learning model is accessed.

At block 515, a first intermediate tensor is generated based on processing the reference latent tensor and the first latent tensor using an auxiliary machine learning model.

At block 520, a second latent tensor is generated, during a second iteration of processing data using the denoising backbone, based on the first latent tensor and at least in part on the first intermediate tensor.

In some aspects, the reference input is an image.

In some aspects, generating the first intermediate tensor comprises combining the reference latent tensor and the first latent tensor.

In some aspects, combining the reference latent tensor and the first latent tensor comprises at least one of adding, concatenating, or averaging the reference latent tensor and the first latent tensor.

In some aspects, the second latent tensor is generated based further on processing a prompt tensor encoding a text input prompt using the auxiliary machine learning model.

In some aspects, generating the second latent tensor comprises providing the first intermediate tensor as input to a first decoder block of the denoising backbone.

In some aspects, the method 500 further includes generating a second intermediate tensor based on processing the reference latent tensor and the first latent tensor using the auxiliary machine learning model, and providing the second intermediate tensor as input to a second decoder block of the denoising backbone, wherein the second latent tensor is generated based further on the second intermediate tensor.

In some aspects, the first intermediate tensor is generated by a first encoder block of the auxiliary machine learning model, and generating the second intermediate tensor comprises processing the first intermediate tensor using a second encoder block of the auxiliary machine learning model.

In some aspects, the denoising backbone comprises a sequence of denoiser encoder blocks and a sequence of decoder blocks, the auxiliary machine learning model comprises a sequence of auxiliary encoder blocks, and each decoder block of the sequence of decoder blocks receives input from (i) a corresponding denoiser encoder block of the sequence of denoiser encoder blocks, and (ii) a corresponding encoder block of the sequence of auxiliary encoder blocks.

In some aspects, an initial block of the sequence of auxiliary encoder blocks corresponds to a final block of the sequence of decoder blocks, and a final block of the sequence of auxiliary encoder blocks corresponds to an initial block of the sequence of decoder blocks.

In some aspects, the method 500 further includes generating a second intermediate tensor based on processing the reference latent tensor and the second latent tensor using the auxiliary machine learning model, and generating a third latent tensor, during a third iteration of processing data using the denoising backbone, based at least in part on the second intermediate tensor.

In some aspects, parameters of the denoising backbone were frozen during training of the auxiliary machine learning model.

In some aspects, generating the first intermediate tensor using the auxiliary machine learning model comprises performing at least one of (i) a convolution operation or (ii) a downsampling operation.

### Example Processing System for Machine Learning

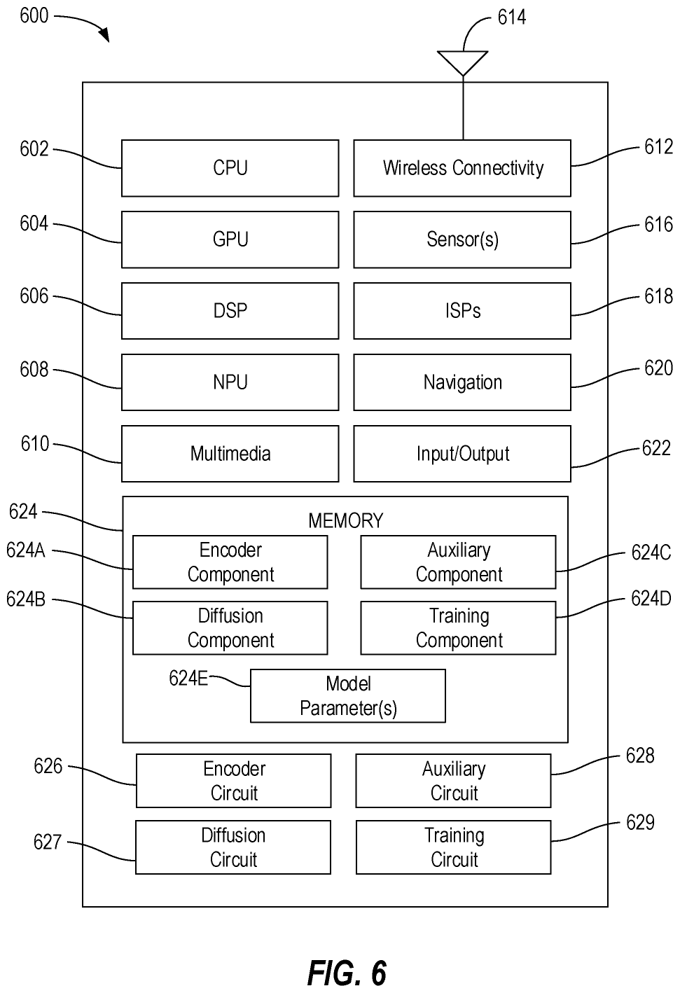

FIG. 6 depicts an example processing system 600 configured to perform various aspects of the present disclosure, including, for example, the techniques and methods described with respect to FIGS. 1-5. In some aspects, the processing system 600 may correspond to a machine learning system. For example, the processing system 600 may correspond to a system that trains machine learning models (e.g., auxiliary models) and/or uses trained machine learning models for image generation. Although depicted as a single system for conceptual clarity, in some aspects, as discussed above, the operations described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes an encoder component 624A, a diffusion component 624B, an auxiliary component 624C, and a training component 624D. Although not depicted in the illustrated example, the memory 624 may also include other components, such as a generation component to manage the generation of data (e.g., edited images) using trained machine learning models, as discussed above. Though depicted as discrete components for conceptual clarity in FIG. 6, the illustrated components (and others not depicted) may be collectively or individually implemented in various aspects.

As illustrated, the memory 624 also includes a set of model parameters 624E (e.g., parameters of one or more machine learning models or components thereof). For example, the model parameters 624E may include parameters for components such as the encoder 115A, the encoder 115B, the denoising backbone 130, and/or the auxiliary machine learning model 135, each of FIG. 1. The model parameters 624E may additionally or alternatively include parameters for components such as the encoder 215A, the encoder 215B, the blocks 230, and/or the blocks 235, each of FIG. 2. Although not depicted in the illustrated example, the memory 624 may also include other data such as training data (e.g., training exemplars including reference images, target images, and text prompts).

The processing system 600 further comprises an encoder circuit 626, a diffusion circuit 627, an auxiliary circuit 628, and a training circuit 629. The depicted circuits, and others not depicted (such as an inferencing circuit), may be configured to perform various aspects of the techniques described herein.

The encoder component 624A and/or the encoder circuit 626 (which may correspond to the encoder(s) 115 of FIG. 1 and/or the encoder(s) 215 of FIG. 2 may be used to generate features, embeddings, or encodings based on input data, as discussed above. For example, the encoder component 624A and/or the encoder circuit 626 may generate prompt embeddings (e.g., the prompt tensor 120 of FIG. 1 and/or the prompt tensor 220 of FIG. 2) and/or latent tensors (e.g., latent tensor 125 of FIG. 1 and/or the latent tensor 225 of FIG. 2).

The diffusion component 624B and/or the diffusion circuit 627 (which may correspond to the denoising backbone 130 of FIG. 1 and/or the blocks 230 of FIG. 2) may be used to iteratively denoise latent tensors based on the prompt text and a set of auxiliary inputs, as discussed above. For example, at each iteration, the diffusion component 624B and/or the diffusion circuit 627 may generate a denoised latent tensor (such as the latent tensor 145 of FIG. 1 and/or the latent tensor 245 of FIG. 2). By processing these latent tensors iteratively (removing noise at each iteration), the diffusion component 624B and/or the diffusion circuit 627 may generate improved output images, as discussed above.

The auxiliary component 624C and/or the auxiliary circuit 628 (which may correspond to the auxiliary machine learning model 135 of FIG. 1 and/or the blocks 235 of FIG. 2) may be used to generate auxiliary guidance or inputs to the denoising backbone, as discussed above. For example, the auxiliary component 624C and/or the auxiliary circuit 628 may process the image encoding, text encoding, and/or latent tensor at each iteration to generate a new set of auxiliary tensors that are used as input to the denoising backbone to guide the diffusion process.

The training component 624D and/or the training circuit 629 may be used to train the machine learning model(s), as discussed above. For example, the training component 624D and/or the training circuit 629 may be used to train the parameters of the auxiliary machine learning model while maintaining the remaining parameters (e.g., of the encoders, denoising backbone, and any other components of the diffusion model) frozen.

Though depicted as separate components and circuits for clarity in FIG. 6, the encoder circuit 626, the diffusion circuit 627, the auxiliary circuit 628, and the training circuit 629 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 maybe distributed between multiple devices.

### Example Clauses

Implementation examples are described in the following numbered clauses:
Clause 1: A method, comprising: accessing a reference latent tensor generated based on a reference input to a diffusion machine learning model; accessing a first latent tensor generated during a first iteration of processing data using a denoising backbone of the diffusion machine learning model; generating a first intermediate tensor based on processing the reference latent tensor and the first latent tensor using an auxiliary machine learning model; and generating a second latent tensor, during a second iteration of processing data using the denoising backbone, based on the first latent tensor and at least in part on the first intermediate tensor.
Clause 2: A method according to Clause 1, wherein the reference input is an image.
Clause 3: A method according to any of Clauses 1-2, wherein generating the first intermediate tensor comprises combining the reference latent tensor and the first latent tensor.
Clause 4: A method according to Clause 3, wherein combining the reference latent tensor and the first latent tensor comprises at least one of adding, concatenating, or averaging the reference latent tensor and the first latent tensor.
Clause 5: A method according to any of Clauses 1-4, wherein the second latent tensor is generated based further on processing a prompt tensor encoding a text input prompt using the auxiliary machine learning model.
Clause 6: A method according to any of Clauses 1-5, wherein generating the second latent tensor comprises providing the first intermediate tensor as input to a first decoder block of the denoising backbone.
Clause 7: A method according to Clause 6, further comprising: generating a second intermediate tensor based on processing the reference latent tensor and the first latent tensor using the auxiliary machine learning model; and providing the second intermediate tensor as input to a second decoder block of the denoising backbone, wherein the second latent tensor is generated based further on the second intermediate tensor.
Clause 8: A method according to Clause 7, wherein: the first intermediate tensor is generated by a first encoder block of the auxiliary machine learning model, and generating the second intermediate tensor comprises processing the first intermediate tensor using a second encoder block of the auxiliary machine learning model.
Clause 9: A method according to any of Clauses 1-8, wherein: the denoising backbone comprises a sequence of denoiser encoder blocks and a sequence of decoder blocks; the auxiliary machine learning model comprises a sequence of auxiliary encoder blocks; and each decoder block of the sequence of decoder blocks receives input from (i) a corresponding denoiser encoder block of the sequence of denoiser encoder blocks, and (ii) a corresponding encoder block of the sequence of auxiliary encoder blocks.
Clause 10: A method according to Clause 9, wherein: an initial block of the sequence of auxiliary encoder blocks corresponds to a final block of the sequence of decoder blocks; and a final block of the sequence of auxiliary encoder blocks corresponds to an initial block of the sequence of decoder blocks.
Clause 11: A method according to any of Clauses 1-10, further comprising: generating a second intermediate tensor based on processing the reference latent tensor and the second latent tensor using the auxiliary machine learning model; and generating a third latent tensor, during a third iteration of processing data using the denoising backbone, based at least in part on the second intermediate tensor.
Clause 12: A method according to any of Clauses 1-11, wherein parameters of the denoising backbone were frozen during training of the auxiliary machine learning model.
Clause 13: A method according to Clause 12, wherein generating the first intermediate tensor using the auxiliary machine learning model comprises performing at least one of (i) a convolution operation or (ii) a downsampling operation.
Clause 14: A processing system comprising: a memory comprising computer-executable instructions; and one or more processors configured to execute the computer-executable instructions and cause the processing system to perform a method in accordance with any of Clauses 1-13.
Clause 15: A processing system comprising means for performing a method in accordance with any of Clauses 1-13.
Clause 16: A non-transitory computer-readable medium comprising computer-executable instructions that, when executed by one or more processors of a processing system, cause the processing system to perform a method in accordance with any of Clauses 1-13.
Clause 17: A computer program product embodied on a computer-readable storage medium comprising code for performing a method in accordance with any of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access a reference latent tensor generated based on a reference input to a diffusion machine learning model;
access a first latent tensor generated during a first iteration of processing data using a denoising backbone of the diffusion machine learning model;
generate a first intermediate tensor based on processing the reference latent tensor and the first latent tensor using an auxiliary machine learning model; and
generate a second latent tensor, during a second iteration of processing data using the denoising backbone, based on the first latent tensor and at least in part on the first intermediate tensor.

2. The processing system of claim 1, wherein, to generate the first intermediate tensor, the one or more processors are configured to execute the processor-executable instructions and cause the processing system to combine the reference latent tensor and the first latent tensor.

3. The processing system of claim 2, wherein, to combine the reference latent tensor and the first latent tensor, the one or more processors are configured to execute the processor-executable instructions and cause the processing system to at least one of add, concatenate, or average the reference latent tensor and the first latent tensor.

4. The processing system of claim 1, wherein, to generate the second latent tensor, the one or more processors are configured to further execute the processor-executable instructions and cause the processing system to process a prompt tensor encoding a text input prompt using the auxiliary machine learning model.

5. The processing system of claim 1, wherein, to generate the second latent tensor, the one or more processors are configured to execute the processor-executable instructions and cause the processing system to provide the first intermediate tensor as input to a first decoder block of the denoising backbone.

6. The processing system of claim 5, wherein the one or more processors are configured to further execute the processor-executable instructions and cause the processing system to:
generate a second intermediate tensor based on processing the reference latent tensor and the first latent tensor using the auxiliary machine learning model; and
provide the second intermediate tensor as input to a second decoder block of the denoising backbone, wherein the second latent tensor is generated based further on the second intermediate tensor.

7. The processing system of claim 6, wherein:
the first intermediate tensor is generated by a first encoder block of the auxiliary machine learning model, and
to generate the second intermediate tensor, the one or more processors are configured to execute the processor-executable instructions and cause the processing system to process the first intermediate tensor using a second encoder block of the auxiliary machine learning model.

8. The processing system of claim 1, wherein:
the denoising backbone comprises a sequence of denoiser encoder blocks and a sequence of decoder blocks;
the auxiliary machine learning model comprises a sequence of auxiliary encoder blocks; and
each decoder block of the sequence of decoder blocks receives input from (i) a corresponding denoiser encoder block of the sequence of denoiser encoder blocks, and (ii) a corresponding encoder block of the sequence of auxiliary encoder blocks.

9. The processing system of claim 8, wherein:
an initial block of the sequence of auxiliary encoder blocks corresponds to a final block of the sequence of decoder blocks; and
a final block of the sequence of auxiliary encoder blocks corresponds to an initial block of the sequence of decoder blocks.

10. The processing system of claim 1, wherein the one or more processors are configured to further execute the processor-executable instructions and cause the processing system to:
generate a second intermediate tensor based on processing the reference latent tensor and the second latent tensor using the auxiliary machine learning model; and
generate a third latent tensor, during a third iteration of processing data using the denoising backbone, based at least in part on the second intermediate tensor.

11. A processor-implemented method, comprising:
accessing a reference latent tensor generated based on a reference input to a diffusion machine learning model;
accessing a first latent tensor generated during a first iteration of processing data using a denoising backbone of the diffusion machine learning model;
generating a first intermediate tensor based on processing the reference latent tensor and the first latent tensor using an auxiliary machine learning model; and
generating a second latent tensor, during a second iteration of processing data using the denoising backbone, based on the first latent tensor and at least in part on the first intermediate tensor.

12. The processor-implemented method of claim 11, wherein generating the first intermediate tensor comprises combining the reference latent tensor and the first latent tensor.

13. The processor-implemented method of claim 12, wherein combining the reference latent tensor and the first latent tensor comprises at least one of adding, concatenating, or averaging the reference latent tensor and the first latent tensor.

14. The processor-implemented method of claim 11, wherein the second latent tensor is generated based further on processing a prompt tensor encoding a text input prompt using the auxiliary machine learning model.

15. The processor-implemented method of claim 11, wherein generating the second latent tensor comprises providing the first intermediate tensor as input to a first decoder block of the denoising backbone.

16. The processor-implemented method of claim 15, further comprising:
generating a second intermediate tensor based on processing the reference latent tensor and the first latent tensor using the auxiliary machine learning model; and
providing the second intermediate tensor as input to a second decoder block of the denoising backbone, wherein the second latent tensor is generated based further on the second intermediate tensor.

17. The processor-implemented method of claim 16, wherein:
the first intermediate tensor is generated by a first encoder block of the auxiliary machine learning model, and
generating the second intermediate tensor comprises processing the first intermediate tensor using a second encoder block of the auxiliary machine learning model.

18. The processor-implemented method of claim 11, wherein:
the denoising backbone comprises a sequence of denoiser encoder blocks and a sequence of decoder blocks;
the auxiliary machine learning model comprises a sequence of auxiliary encoder blocks; and
each decoder block of the sequence of decoder blocks receives input from (i) a corresponding denoiser encoder block of the sequence of denoiser encoder blocks, and (ii) a corresponding encoder block of the sequence of auxiliary encoder blocks.

19. The processor-implemented method of claim 18, wherein:
an initial block of the sequence of auxiliary encoder blocks corresponds to a final block of the sequence of decoder blocks; and
a final block of the sequence of auxiliary encoder blocks corresponds to an initial block of the sequence of decoder blocks.

20. The processor-implemented method of claim 11, further comprising:
generating a second intermediate tensor based on processing the reference latent tensor and the second latent tensor using the auxiliary machine learning model; and
generating a third latent tensor, during a third iteration of processing data using the denoising backbone, based at least in part on the second intermediate tensor.
